(19) United States
(12) Patent Application Publication
(10) Pub. No.: US 2013/0183739 A1
(43) Pub. Date: Jul. 18, 2013

(54) Mixed Feedstocks Processing Using an Ionic Liquid

(71) Applicants: Seema Singh, Fremont, CA (US); Rohit Arora, Pomona, CA (US); Chenlin Li, Albany, CA (US); Ian P. Mathews, Berkeley, CA (US); Blake A. Simmons, San Francisco, CA (US)

(72) Inventors: Seema Singh, Fremont, CA (US); Rohit Arora, Pomona, CA (US); Chenlin Li, Albany, CA (US); Ian P. Mathews, Berkeley, CA (US); Blake A. Simmons, San Francisco, CA (US)

(73) Assignees: THE REGENTS OF THE UNIVERSITY OF CALIFORNIA, Oakland, CA (US); SANDIA CORPORATION, Livermore, CA (US)

(21) Appl. No.: 13/550,437

(22) Filed: Jul. 16, 2012

Related U.S. Application Data
(60) Provisional application No. 61/508,038, filed on Jul. 14, 2011.

(51) Int. Cl. C08B 37/00

(52) U.S. Cl. CPC C08B 37/0003
USPC 435/209; 127/67; 435/274; 252/182.12

(57) ABSTRACT

The present invention provides for a composition comprising two or more feedstocks and an ionic liquid (IL). The present invention also provides for a method for treating feedstocks, comprising providing a composition of the present invention comprising two or more feedstocks and an ionic liquid (IL).

### RELATED PATENT APPLICATIONS

The application claims priority to U.S. Provisional Patent Application Ser. No. 61/508,038, filed Jul. 14, 2011, which is herein incorporated by reference in its entirety.

### STATEMENT OF GOVERNMENTAL SUPPORT

The invention was made with government support under Contract Nos. DE-AC02-05CH11231 awarded by the U.S. Department of Energy. The government has certain rights in the invention.

### FIELD OF THE INVENTION

The present invention is in the field of saccharification of biomass using ionic liquid.

### BACKGROUND OF THE INVENTION

Efficient and cost-effective biomass pretreatment remains one of the most significant hurdles towards the realization of biofuels that can displace fossil fuels. Pretreatment represents one of the most significant costs from an operational perspective, and as such researchers are developing novel biomass pretreatments to help drive the overall costs of the biorefinery down. One cause of this expense, and limited deployment thus far, for the more common biomass pretreatments (e.g., dilute acids, autohydrolysis, dilute bases, organic solvents, steam explosion, lime) is that they are only effective on a narrow range of the available lignocellulosic feedstocks. For instance, while dilute acid and ammonia fiber expansion may be relatively effective in pretreating grasses and corn stovers, they are not that effective in pretreating soft woods and hard woods. No pretreatment currently exists that is known to efficiently pretreat and liberate sugars from mixed feedstock streams (e.g., hardwoods, softwoods, grasses, and agricultural residues fed simultaneously).

### SUMMARY OF THE INVENTION

The present invention provides for a composition comprising two or more feedstocks and an ionic liquid (IL). The composition can have a temperature ranging from about room temperature or 25° C. to about 200° C. The composition can have incubated under certain temperature and other conditions for equal to or more than 1 h, 2 h, or 3 h. After the composition has undergone such an incubation, one or more suitable cellulases, or functional variant thereof, can be introduced or added to the composition, such that the composition further comprises one or more suitable cellulases, or functional variant thereof.

The present invention provides for a method for treating feedstocks, comprising providing a composition of the present invention comprising two or more feedstocks and an ionic liquid (IL). In some embodiments of the invention, the providing step comprises adding and/or mixing two or more feedstocks and an ionic liquid (IL) to a solution to form a composition.

In some embodiments of the invention, the method further comprises introducing a suitable cellulase, or functional variant thereof, to the composition, and hydrolyzing the cellulose in the composition with the cellulase, or functional variant thereof, to produce one or more sugar.

The present invention can be used in the treatment of feedstocks for the extraction of sugars from treated biomass. The sugars recovered can be then used in any process that uses 6-carbon sugars, such as glucose, and the resulting sugars can be used for any intended purpose. The process is of significant interest in biomass processing or biofuels and other biomaterials.

The practice of the present invention can result in recovery of a higher tonnage of biomass per acre and an increase in energy density.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows monosaccharides released from ionic liquid pretreated biomass at 6 h of enzymatic saccharification.

FIG. 2 shows normalized sugar recovery from ionic liquid pretreated biomass at 6 h of enzymatic saccharification.

FIG. 3 shows monosaccharides released from ionic liquid pretreated biomass at 5 day of enzymatic saccharification.

FIG. 4 shows normalized sugar recovery from untreated biomass at 5 day of enzymatic saccharification.

FIG. 5 shows the sugar yield using a treatment method of this invention.

FIG. 6 shows the saccharification kinetics using a treatment method of this invention.

FIG. 7 shows the sugar yield using a treatment method of this invention.

FIG. 8 shows the monosaccharide released using a treatment method of this invention.

FIG. 9 shows the polysaccharide released using a treatment method of this invention.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only, and is not intended to be limiting.

As used in the specification and the appended claims, the singular forms “a,” “an,” and “the” include plural referents unless the context clearly dictates otherwise. Thus, for example, reference to an “IL” includes a single IL compound as well as a plurality of IL compounds, either the same (e.g., the same molecule) or different.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “functional variant” describes an enzyme that has a polypeptide sequence that is at least 70%, 75%, 80%, 85%, 90%, 95% or 99% identical to any one of the enzymes referenced to herein. The “functional variant” enzyme may retain amino acids residues that are recognized as conserved for the enzyme, and may have non-conserved amino acid residues substituted or found to be of a different amino acid, or amino acid(s) inserted or deleted, but which does not affect or has insignificant effect its enzymatic activity, as compared to the enzyme referenced to herein. The “functional variant” enzyme has an enzymatic activity that is identical or essentially identical to the enzymatic activity of the enzyme referenced to herein. The “functional variant” enzyme may be found in nature, i.e. naturally occurring, or be an engineered mutant thereof.

The present invention provides for a composition comprising two or more feedstocks and an ionic liquid (IL). The composition can have a temperature ranging from about room temperature or 25° C. to about 200° C. The composition can have a temperature ranging from about 50° C. to about 200° C. The composition can have a temperature ranging from about 100° C. to about 200° C. The composition can have a temperature ranging from about 150° C. to about 200° C. The composition can have incubated under certain temperature and other conditions for equal to or more than 1 h, 2 h, or 3 h. After the composition has undergone such an incubation, one or more suitable cellulases, or functional variant thereof, can be introduced or added to the composition, such that the composition further comprises one or more suitable cellulases, or functional variant thereof.

TABLE 1
Combination of feedstocks (each combination is indicated by
a two to four letter code):

| | | | | Agricultural |
|---|---|---|---|---|
| | | | | residues/ |
| Feedstock | Softwood | Hardwood | Grass | byproducts |
| combination | feedstock | feedstock | feedstock | feedstock |
| SHGA | + | + | + | + |
| SHG | + | + | + | − |
| HGA | − | + | + | + |
| SGA | + | − | + | + |
| SH | + | + | − | − |
| SG | + | − | + | − |
| SA | + | − | | + |
| HG | − | + | + | − |
| HA | − | + | − | + |
| GA | − | − | + | + |

Each feedstock in the composition can further comprise two or more different species of plants.

Softwood feedstocks include, but are not limited to, Araucaria (e.g. A. cunninghamii, A. angustifolia, A. araucana); softwood Cedar (e.g. Juniperus virginiana, Thuja plicata, Thuja occidentalis, Chamaecyparis thyoides Callitropsis nootkatensis); Cypress (e.g. Chamaecyparis, Cupressus Taxodium, Cupressus arizonica, Taxodium distichum, Chamaecyparis obtusa, Chamaecyparis lawsoniana, Cupressus semperviren); Rocky Mountain Douglas fir; European Yew; Fir (e.g. Abies balsamea, Abies alba, Abies procera, Abies amabilis); Hemlock (e.g. Tsuga canadensis, Tsuga mertensiana, Tsuga heterophylla); Kauri; Kaya; Larch (e.g. Larix decidua, Larix kaempferi, Larix laricina, Larix occidentalis); Pine (e.g. Pinus nigra, Pinus banksiana, Pinus contorta, Pinus radiata, Pinus ponderosa, Pinus resinosa, Pinus sylvestris, Pinus strobus, Pinus monticola, Pinus lambertiana, Pinus taeda, Pinus palustris, Pinus rigida, Pinus echinata); Redwood; Rimu; Spruce (e.g. Picea abies, Picea mariana, Picea rubens, Picea sitchensis, Picea glauca); Sugi; and combinations/hybrids thereof.

For example, softwood feedstocks which may be used herein include cedar; fir; pine; spruce; and combinations thereof. The softwood feedstocks for the present invention may be selected from loblolly pine (Pinus taeda), radiata pine, jack pine, spruce (e.g., white, interior, black), Douglas fir, Pinus silvestris, Picea abies, and combinations/hybrids thereof. The softwood feedstocks for the present invention may be selected from pine (e.g. Pinus radiata, Pinus taeda); spruce; and combinations/hybrids thereof.

Hardwood feedstocks include, but are not limited to, Acacia; Afzelia; Synsepalum duloificum; Albizia; Alder (e.g. Alnus glutinosa, Alnus rubra); Applewood; Arbutus; Ash (e.g. F. nigra, F. quadrangulata, F. excelsior, F. pennsylvanica lanceolata, F. latifolia, F. profunda, F. americana); Aspen (e.g. P. grandidentata, P. tremula, P. tremuloides); Australian Red Cedar (Toona ciliata); Ayna (Distemonanthus benthamianus); Balsa (Ochroma pyramidale); Basswood (e.g. T. americana, T. heterophylla); Beech (e.g. F. sylvatica, F. grandifolia); Birch; (e.g. Betula populifolia, B. nigra, B. papyrifera, B. lenta, B. alleghaniensis/B. lutea, B. pendula, B. pubescens); Blackbean; Blackwood; Bocote; Boxelder; Boxwood; Brazilwood; Bubing a; Buckeye (e.g. Aesculus hippocastanum, Aesculus glabra, Aesculus flava/Aesculus octandra); Butternut; Catalpa; Chemy (e.g. Prunus serotina, Prunus pennsylvanica, Prunus avium); Crabwood; Chestnut; Coachwood; Cocobolo; Corkwood; Cottonwood (e.g. Populus balsamifera, Populus deltoides, Populus sargentii, Populus heterophylla); Cucumbertree; Dogwood (e.g. Cornus florida, Cornus nuttallii); Ebony (e.g. Diospyros kurzii, Diospyros melanida, Diospyros crassiflora); Elm (e.g. Ulmus americana, Ulmus procera, Ulmus thomasii, Ulmus rubra, Ulmus glabra); Eucalyptus; Greenheart; Grenadilla; Gum (e.g. Nyssa sylvatica, Eucalyptus globulus, Liquidambar styraciflua, Nyssa aquatica); Hickory (e.g. Carya alba, Carya glabra, Carya ovata, Carya laciniosa); Hornbeam; Hophornbeam; Ipë; Iroko; Ironwood (e.g. Bangkirai, Carpinus caroliniana, Casuarina equisetifolia, Choricbangarpia subargentea, Copaifera spp., Eusideroxylon zwageri, Guajacum officinale, Guajacum sanctum, Hopea odorata, Ipe, Krugiodendronferreum, Lyonothamnus lyonii (L. floribundus), Mesua ferrea, Olea spp., Olneya tesota, Ostrya virgin iana, Parrotia persica, Tabebuia serratifolia); Jacarandá; Jotoba; Lacewood; Laurel; Limba; Lignum vitae; Locust (e.g. Robinia pseudacacia, Gleditsia triacanthos); Mahogany; Maple (e.g. Acer saccharum, Acer nigrum, Acer negundo, Acer rubrum, Acer saccharinum, Acer pseudoplatanus); Meranti; Mpingo; Oak (e.g. Quercus macrocarpa, Quercus alba, Quercus stellata, Quercus bicolor, Quercus virginiana, Quercus michauxii, Quercus prinus, Quercus muhlenbergii, Quercus chrysolepis, Quercus lyrata, Quercus robur, Quercus petraea, Quercus rubra, Quercus velutina, Quercus laurifolia, Quercus falcata, Quercus nigra, Quercus phellos, Quercus texana); Obeche; Okoumé; Oregon Myrtle; California Bay Laurel; Pear; Poplar (e.g. P. balsamifera, P. nigra, Hybrid Poplar (Populusxcanadensis)); Ramin; Red cedar; Rosewood; Sal; Sandalwood; Sassafras; Satinwood; Silky Oak; Silver Wattle; Snakewood; Sourwood; Spanish cedar; American sycamore; Teak; Walnut (e.g. Juglans nigra, Juglans regia); Willow (e.g. Salix nigra, Salix alba); Yellow poplar (Liriodendron tulipifera); Bamboo; Palmwood; and combinations/hybrids thereof.

For example, hardwood feedstocks for the present invention may be selected from Acacia, Aspen, Beech, Eucalyptus, Maple, Birch, Gum, Oak, Poplar, and combinations/hybrids thereof. The hardwood feedstocks for the present invention may be selected from Populus spp. (e.g. Populus tremuloides), Eucalyptus spp. (e.g. Eucalyptus globulus), Acacia spp. (e.g. Acacia dealbata), and combinations thereof.

Grass feedstocks include, but are not limited to, C₄ or C₃ grasses, e.g. Switchgrass, Indiangrass, Big Bluestem, Little Bluestem, Canada Wildrye, Virginia Wildrye, and Goldenrod wildflowers, etc, amongst other species known in the art.

Agricultural feedstocks include, but are not limited to, agricultural byproducts such as husks, stovers, foliage, and the like. Such agricultural byproducts can be derived from crops for human consumption, animal consumption, or other non-consumption purposes. Such crops can be corps such as corn, wheat, rice, soybeans, hay, potatoes, cotton, or sugarcane.

The combination of feedstocks can arise from the harvesting of crops from the following practices: intercropping, mixed intercropping, row cropping, relay cropping, and the like.

### Ionic liquid (IL)

The suitable IL that can be used in the present invention can be any IL that is suitable for pretreatment of biomass and optionally for the hydrolysis of cellulose by thermostable cellulase. Suitable IL are taught in ChemFiles (2006) 6(9) (which are commercially available from Sigma-Aldrich; Milwaukee, Wis.). Such suitable IL include, 1-alkyl-3-alkylimidazolium alkanate, 1-alkyl-3-alkylimidazolium alkylsulfate, 1-alkyl-3-alkylimidazolium methylsulfonate, 1-alkyl-3-alkylimidazolium hydrogensulfate, 1-alkyl-3-alkylimidazolium thiocyanate, and 1-alkyl-3-alkylimidazolium halide, wherein an “alkyl” is an alkyl group comprising from 1 to 10 carbon atoms, and an “alkanate” is an alkanate comprising from 1 to 10 carbon atoms. In some embodiments, the “alkyl” is an alkyl group comprising from 1 to 4 carbon atoms. In some embodiments, the “alkyl” is a methyl group, ethyl group or butyl group. In some embodiments, the “alkanate” is an alkanate comprising from 1 to 4 carbon atoms. In some embodiments, the “alkanate” is an acetate. In some embodiments, the halide is chloride.

Such suitable IL include, but are limited to, 1-ethyl-3-methylimidazolium acetate (EMIN Acetate), 1-ethyl-3-methylimidazolium chloride (EMIN CI), 1-ethyl-3-methylimidazolium hydrogensulfate (EMIM HOSO₃), 1-ethyl-3-methylimidazolium methylsulfate (EMIM MeOSO₃), 1-ethyl-3-methylimidazolium ethylsulfate (EMIM EtOSO₃), 1-ethyl-3-methylimidazolium methanesulfonate (EMIM MeSO₃), 1-ethyl-3-methylimidazolium tetrachloroaluminate (EMIM AlCl₄), 1-ethyl-3-methylimidazolium thiocyanate (EMIM SCN), 1-butyl-3-methylimidazolium acetate (BMIM Acetate), 1-butyl-3-methylimidazolium chloride (BMIM Cl), 1-butyl-3-methylimidazolium hydrogensulfate (BMIM HOSO₃), 1-butyl-3-methylimidazolium methanesulfonate (BMIM MeSO₃), 1-butyl-3-methylimidazolium methylsulfate (BMIM MeOSO₃), 1-butyl-3-methylimidazolium tetrachloroaluminate (BMIM AlCl₄), 1-butyl-3-methylimidazolium thiocyanate (BMIM SCN), 1-ethyl-2,3-dimethylimidazolium ethylsulfate (EDIM EtOSO₃), Tris(2-hydroxyethyl)methylammonium methylsulfate (MTEOA MeOSO₃), 1-methylimidazolium chloride (MIM Cl), 1-methylimidazolium hydrogensulfate (MIM HOSO₃), 1,2,4-trimethylpyrazolium methylsulfate, tributylmethylammonium methylsulfate, choline acetate, choline salicylate, and the like. The ionic liquid can comprises one or a mixture of the compounds. Further ILs are taught in U.S. Pat. No. 6,177,575; herein incorporated by reference.

The ionic liquid (IL) is of a concentration of more than 0% to 100% of the composition or solution. In some embodiments, the IL is of a concentration of more than 0% to less than 60% of the composition or solution. In some embodiments, the concentration of IL is equal to or more than 1%, equal to or more than 2%, equal to or more than 3%, equal to or more than 5%, equal to or more than 10%, equal to or more than 15%, or equal to or more than 20%. The upper range of the concentration of IL is less than 60%, or equal to or less than 55%.

In some embodiments of the invention, the IL has a concentration from more than 0% to about 50%. In some embodiments of the invention, the IL has a concentration from more than 0% to about 35%. In some embodiments of the invention, the IL has a concentration from more than 0% to about 20%. In some embodiments of the invention, the IL has a concentration from about 5% to about 20%.

### Temperature of the Composition

The composition can have a temperature ranging from about room temperature to about 200° C. The composition can have a temperature ranging from about 100° C. to about 200 ° C. The composition can have a temperature ranging from about 120° C. to about 180° C. The composition can have a temperature ranging from about 120° C. to about 160° C. The composition can have a temperature equal to or more than about room temperature. The composition can have a temperature equal to or more than about 50° C., 100° C., 120° C., or 150° C. The composition can have a temperature equal to or more than about 160° C.

### Methods of the Present Invention

The present invention provides for a method for treating feedstocks, comprising providing a composition of the present invention comprising two or more feedstocks and an ionic liquid (IL). In some embodiments of the invention, the providing step comprises adding and/or mixing two or more feedstocks and an ionic liquid (IL) to a solution to form a composition.

In some embodiments of the invention, the method further comprises introducing a suitable cellulase, or functional variant thereof, to the composition, and hydrolyzing the cellulose in the composition with the cellulase, or functional variant thereof, to produce one or more sugar.

The monosaccharides including fucose, arabinose, rhamnose, galactose, mannose, xylose, glucose, glucuronic acid and galacturonic acid. The monosaccharides including C6 sugars.

The method can produce a sugar yield of equal to or more than about 0.2 mg/mL, 0.4 mg/mL, 0.6 mg/mL, 0.8 mg/mL, 0.9 mg/mL, or 1.0 mg/mL.

In some embodiments of the invention, the method comprises the following pretreatment protocol: incubating the mixed feedstocks in an IL, such as 1-ethyl-3-methyl imidazolium acetate ([C2mim]), at 160° C. for 3 hours, with a 3% loading (300 mg solids/9.7 ml[C2mim][OAc]). The method can further comprise using hot water (95 C.) as anti-solvent used for washing, and 2-3 grams of pretreated material of each biomass produced.

A protocol for enzyme saccharification comprises providing a solution comprising: (1) Biomass 750 mg, (2) 50 mM Sodium Citrate Buffer 5 ml, pH 5.0, (3) CTec2 cellulase 40 mg/g-glucan, and (4) HTec2 cellulase 4 mg/g-xylan. Measurements can be taken at the following time intervals: 0 h, 6 h, 24 h, 48 h, 72 h, 96 h, 120 h, and 144 h.

Hydrolysate monosaccharides can be measured using the following protocol: (1) Transfer 10 μl supernatant and make 1000× dilution with Dl water. (2) The monosaccharides including fucose, arabinose, rhamnose, galactose, mannose, xylose, glucose, glucuronic acid and galacturonic acid are prepared at the levels of 0-100 μM and used as the external standards. (3) A calibration curve is set up using external standards and then analyze the hydrolysates using High Pressure Anion Exchange Chromatograph (HPAEC) with an electrochemical detector and a 4×250 mm CarboPac PA20 analytical column. Elution is initiated with 97.2% (v/v) water and 2.8% (v/v) 1 M NaOH for the first 15 min, with a 20 μl injection volume. The elution fluid is then switched directly to 55.0% (v/v) water and 45.0% (v/v) 1 M NaOH for the next 20 min and returned to 97.2% (v/v) water and 2.8% (v/v) 1 M NaOH for the last 10 min to equilibrate the column. The flow rate can be 0.5 ml/min.

In some embodiments of the invention, the method further comprises recovering the sugar from the composition, and optionally culturing a cell using the sugar obtained from the recovering step. In some embodiments of the invention, the cell produces a molecule of interest. In some embodiments of the invention, the molecule of interest is a biofuel.

### Suitable Cellulase

Such suitable cellulases are capable of hydrolyzing cellulose in the presence of IL. The cellulase can be an endoglucanase or an exoglucanase. The cellulase can be a thermostable cellulase. In some embodiments of the invention, the cellulase is one described in the following: U.S. Provisional Patent Application Ser. Nos. 61/495,893, filed Jun. 10, 2011; 61/481,642, filed May 2, 2011; 61/172,653, filed Apr. 24, 2009; 61/172,668, filed Apr. 24, 2009; 61/495,893, filed Jun. 10, 2011; and, 61/246,439, filed Sep. 28, 2009; U.S. patent application Ser. No. 12/892,724, filed Sep. 28, 2010; and, WO 2010/124266. The hydrolysates generated from such mixed feedstocks are suitable for the production of advanced biofuels and/or biofuel precursors through microbial fermentation. There are at least four different kinds of feedstocks: softwoods, hardwoods, grasses, and agricultural residues/byproducts. The composition can comprise one of the following combination of feedstocks indicated in Table 1.

### Applications

The present invention can be used in the treatment of feedstocks for the extraction of sugars from treated biomass. The sugars recovered can be then used in any process that uses 6-carbon sugars, such as glucose, and the resulting sugars can be used for any intended purpose. The process is of significant interest in biomass processing or biofuels and other biomaterials.

The practice of the present invention can result in recovery of a higher tonnage of biomass per acre and an increase in energy density.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

The invention having been described, the following examples are offered to illustrate the subject invention by way of illustration, not by way of limitation.

### EXAMPLE 1

### Mixed Feedstock Processing with Ionic Liquid

### Materials and Methods

### Raw Materials

The raw material used were pine (Pinus radiata), eucalyptus (Eucalyptus globules, switchgrass (Panicum virgatum L.), and corn stover containing corn cobs without grain (NK brand N33-J4), which was harvested from farms in 2008. All samples were milled with a Thomas-Wiley® Mini Mill fitted with a 40-mesh screen (Model 3383-L10 Arthur H. Thomas Co., Philadelphia, Pa.) and air dried until the moisture was less than 10%. The samples were stored at 4° C. in a sealed plastic bag for use in all experimentation.

Cellic CTec2 (cellulase) and HTec2 (endoxylanase) were obtained from Novozymes (Davis, Calif.). Ionic liquid, 1-ethyl-3-methylimidazolium acetate ([C2 mim][OAc]), sodium citrate, and sodium hydroxide were purchased from Sigma-Aldrich (St. Louis, Mo.).

### Biomass Pretreatments and Regeneration

A 3% (w/w) biomass solution (either individual or equally mixed) was prepared by combining 300 mg of sample with 9.7 g [C2 mim][OAc] in a 50 mL autoclave vial. The vials and the contents were heated in conventional oven at 160° C. for 3 h. All experiments were conducted in triplicates. After 3 h incubation, 30 mL of deionized water was slowly added into the stirred biomass/[C2 mim][OAc] slurry for regeneration of the solubilized biomass. A precipitate immediately formed, and the sample was centrifuged at 10,000 g for 10 min. The supernatant containing ionic liquid was removed, and the precipitate was washed four times with additions of water to remove the excess ionic liquid. The cleaned precipitated solid is then lyophilized and the final samples are weighed and kept at 4° C. for the further experiment.

### Sugar Characterization of Three Biomass Samples

Structural carbohydrates of either individual or mixed biomass before and after pretreatment, including cellulose, xylan, arabinan, and galactan, were determined according to the analytical procedure of the National Renewable Energy Laboratory (NREL) by two-step acid hydrolysis (Sluiter et al., 2004a; Sluiter et al., 2004b). Carbohydrates were analyzed by HPAEC on an ICS-3000 system (Dionex, Sunnyvale, Calif.) equipped with an electrochemical detector and a 4×250 mm CarboPac PA20 analytical column (Li et al., 2010). Elution was initiated with 97.2% (v/v) water and 2.8% (v/v) 1 M NaOH for the first 15 min, with a 20 μL injection volume. The elution fluid was then switched directly to 55.0% (v/v) water and 45.0% (v/v) 1 M NaOH for the next 20 min and returned to 97.2% (v/v) water and 2.8% (v/v) 1M NaOH for the last 10 min to equilibrate the column. The flow rate was 0.5 mL/min. The monosaccharides including fucose, arabinose, rhamnose, galactose, mannose, xylose, glucose, glucuronic acid, and galacturonic acid used as the external standards for HPAEC were obtained from Sigma-Aldrich and Alfa Aesar (Ward Hill, Mass.) and prepared at levels of 0 to 5 mM before use.

### Enzymatic Saccharification

Batch enzymatic saccharification of pretreated and untreated biomass samples was carried out at 50° C. and 150 rpm in a reciprocating shaker. All samples were kept at 15% (W/V) biomass loading in 50 mM sodium citrate buffer with pH at 4.5 for enzymatic hydrolysis. The total batch volume was 5 mL with cellulase (CTec2) concentration of 40 mg protein/g glucan and endoxylanase (HTec2) concentration of 4 mg protein/g xylan. The reaction was monitored by taking 50 μL supernatant at specific time intervals, followed by centrifugation at 10,000 g for 5 minutes. Then 10 μL of supernatant was transferred and diluted with Deionized water, then analyzed using HPAEC for monosaccharides in the hydrolysates.

### Results

Chemical compositions of untreated and pretreated feedstocks

As shown in Table 2, comparing with untreated biomass, pretreated individual and mixed feedstock under ionic liquid pretreatment have significantly decreased hemicellulose contents and enriched glucan contents.

TABLE 2
Sugar compositions of untreated and ionic liquid
pretreated feedstocks.

| Feed- | | Sugar compositions (%) | | | | |
|---|---|---|---|---|---|---|
| stocks | | Glucan | Xylan | Arabinan | Galactan | Mannan |
| Mixed | Untreated | 37.9 | 14.9 | 1.8 | 1.6 | ND |
| Mixed | Pretreated | 55.8 | 3.6 | 0.7 | 0.7 | ND |
| Pine | Untreated | 38.2 | 12.2 | 2.3 | 2.4 | 5.1 |
| Pine | Pretreated | 39.6 | 5.3 | 0.8 | 1.1 | ND |
| Euca- | Untreated | 41.7 | 14.3 | 2.0 | 3.2 | 2.6 |
| lyptus | | | | | | |
| Euca- | Pretreated | 55.3 | 7.2 | 0.3 | 0.6 | ND |
| lyptus | | | | | | |
| Switch- | Untreated | 39.5 | 20.3 | 2.1 | 2.6 | ND |
| grass | | | | | | |
| Switch- | Pretreated | 60.4 | 2.5 | 0.9 | 0.4 | ND |
| grass | | | | | | |
| Corn | Untreated | 34.9 | 21.7 | 2.8 | 3.5 | ND |
| Stover | | | | | | |
| Corn | Pretreated | 68.8 | 7.4 | 1.2 | 0.5 | ND |
| Stover | | | | | | |

### Enzymatic Saccharification

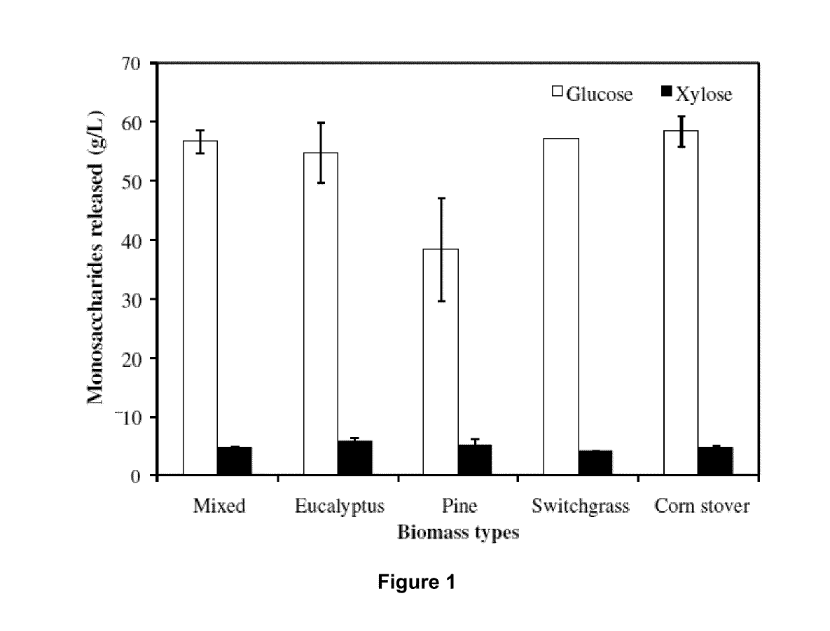

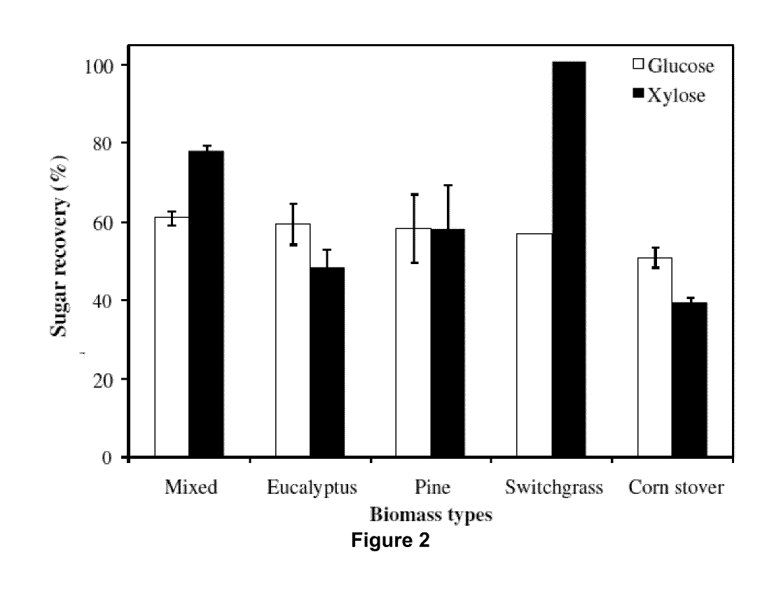

FIGS. 1 and 2 show the glucose and xylose released very quick within 6 h of enzymatic saccharification with the glucose recovery of 50-60% and xylose recovery of 40-100% from mixed feedstocks, eucalyptus, pine, switchgrass and corn stover. Further observation shows that the sugar release already leveled off at 6 h and the longer saccharification results (data not shown here) did not show obvious sugar increase by measurement at 24 h, 48 h, 72 h, 96 h and up to 120 h. These results show that saccharification of ionic liquid pretreated feedstocks is very fast and efficient at solid loading as high as 15%. Some inhibitors may present, such as residual ionic liquid, at this high solid loading condition and could inhibit the enzymes from achieving complete hydrolysis.

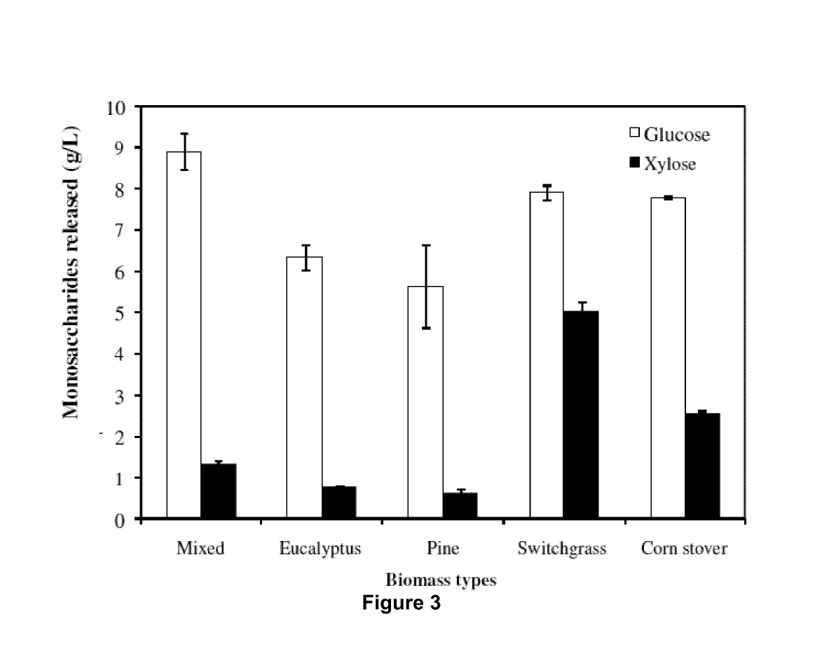

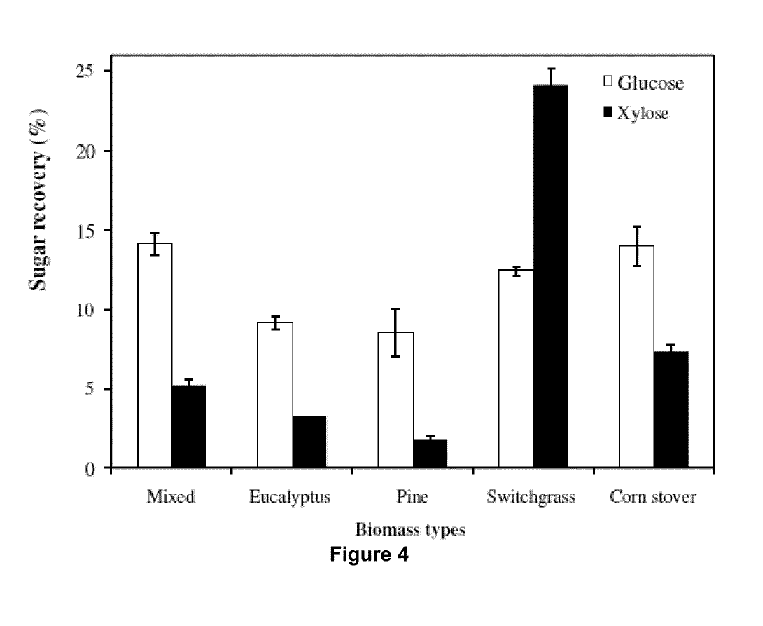

FIGS. 3 and 4 show the data from control experiments using untreated feedstocks under same conditions for enzymatic saccharification. Results show that at 5 day of saccharification, the glucose and xylose were only released 8-14% and 2-24%, respectively.

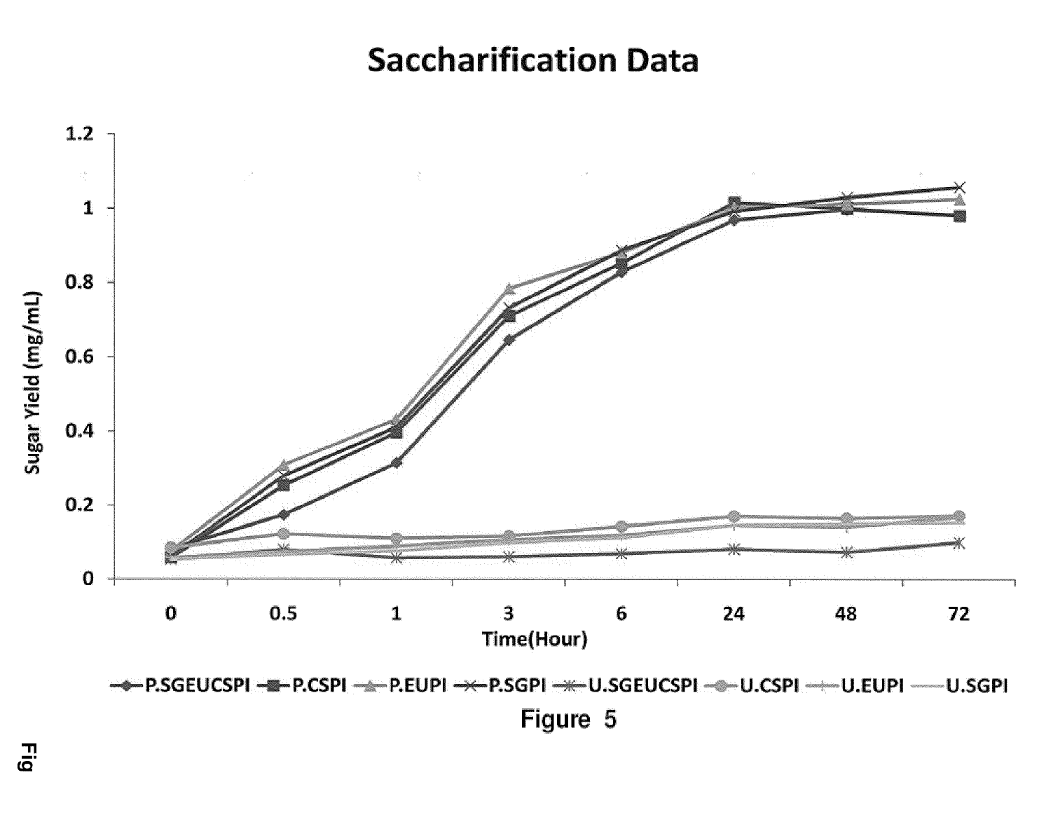

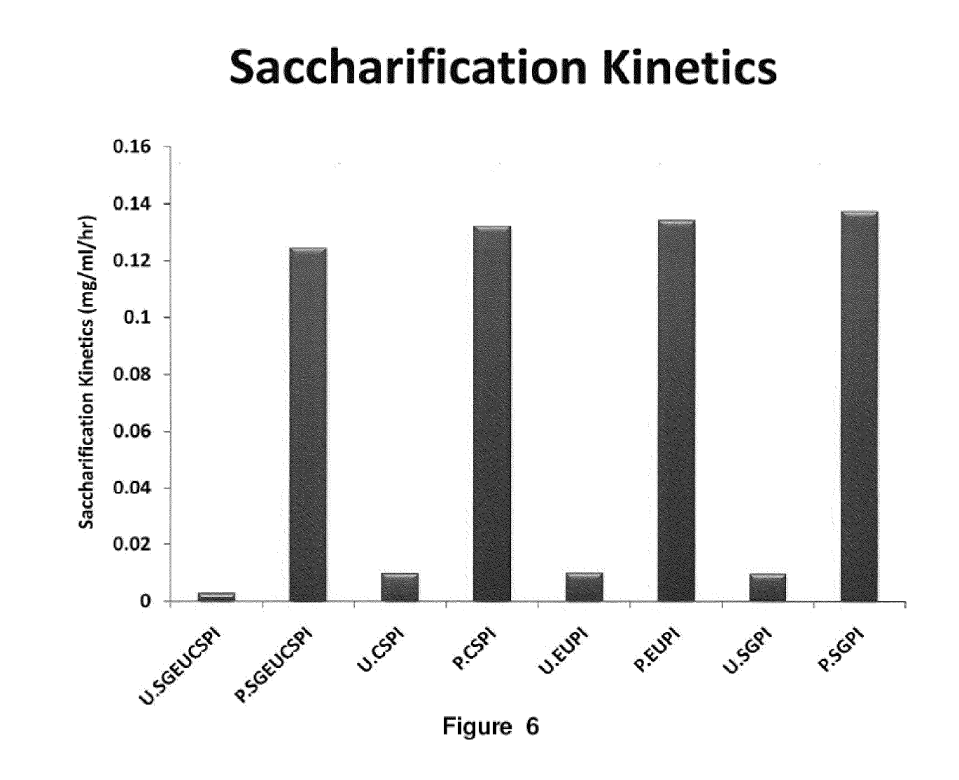

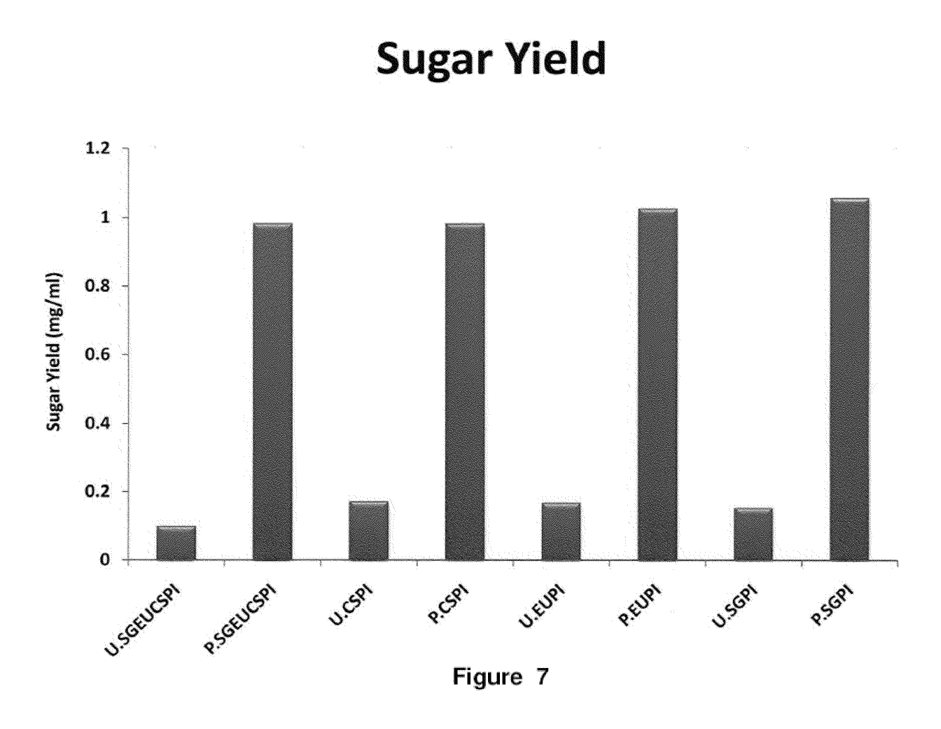

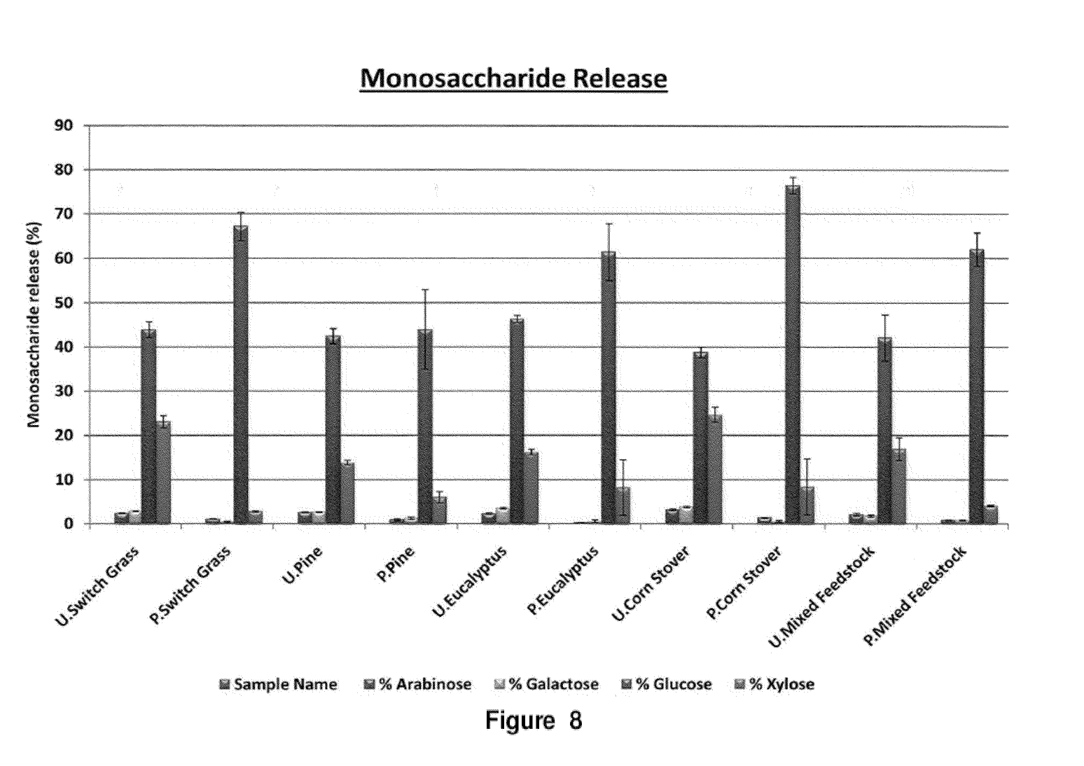

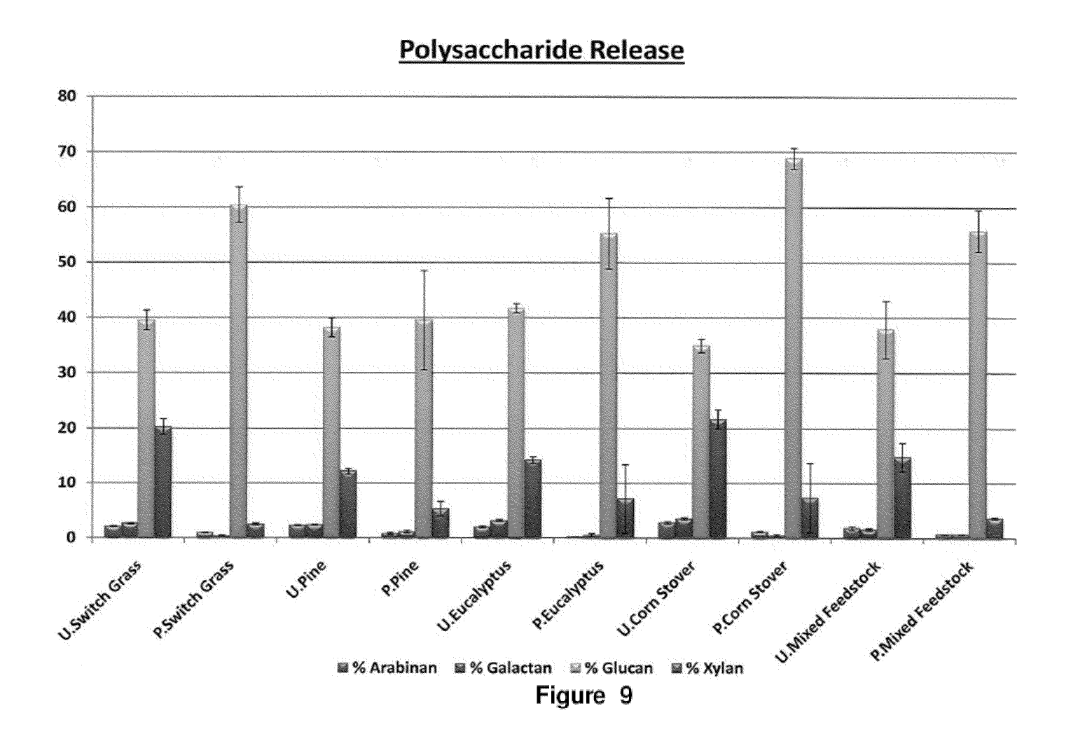

FIGS. 5-9 show the data using a treatment method of this invention. Table 3 shows the percent monosaccharide released using a treatment method of this invention. Table 4 shows the percent polysaccharide released using a treatment method of this invention.

TABLE 3
Monosaccharide release.

| Sample | | | | |
|---|---|---|---|---|
| Name | % Arabinose | % Galactose | % Glucose | % Xylose |
| U. Switch | 2.386081889 | 2.888888889 | 43.88888889 | 23.06545826 |
| Grass | | | | |
| P. Switch | 1.0837041 | 0.44676351 | 67.14935639 | 2.821924798 |
| Grass | | | | |
| U. Pine | 2.613327783 | 2.666666667 | 42.44444444 | 13.86199955 |
| P. Pine | 0.919603523 | 1.247512212 | 43.95259893 | 6.048674983 |
| U. | 2.272458942 | 3.555555556 | 46.33333333 | 16.24808143 |
| Eucalyptus | | | | |
| P. | 0.302393721 | 0.616107258 | 61.42377474 | 8.197647925 |
| Eucalyptus | | | | |
| U. Corn | 3.181442519 | 3.888888889 | 38.77777778 | 24.65617952 |
| Stover | | | | |
| P. Corn | 1.343233029 | 0.548842456 | 76.44528474 | 8.367965153 |
| Stover | | | | |
| U. Mixed | 2.056914416 | 1.729901516 | 42.08866131 | 16.90627717 |
| Feedstock | | | | |
| P. Mixed | 0.785412226 | 0.777009723 | 62.0508187 | 4.124506855 |
| Feedstock | | | | |

TABLE 4
Polysaccharide release.

| Sample Name | % Arabinan | % Galactan | % Glucan | % Xylan |
|---|---|---|---|---|
| U. Switch Grass | 2.1 | 2.6 | 39.5 | 20.3 |
| P. Switch Grass | 0.953772216 | 0.402087159 | 60.434421 | 2.483587 |
| U. Pine | 2.3 | 2.4 | 38.2 | 12.2 |
| P. Pine | 0.809346656 | 1.12276099 | 39.557339 | 5.323463 |
| U. Eucalyptus | 2 | 3.2 | 41.7 | 14.3 |
| P. Eucalyptus | 0.266137896 | 0.554496533 | 55.281397 | 7.214782 |
| U. Corn Stover | 2.8 | 3.5 | 34.9 | 21.7 |
| P. Corn Stover | 1.182184641 | 0.493958211 | 68.800756 | 7.364679 |
| U. Mixed Feedstock | 1.81029842 | 1.556911364 | 37.879795 | 14.87928 |
| P. Mixed Feedstock | 0.691244371 | 0.699308751 | 55.845737 | 3.629995 |

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

We claim:

1. A composition comprising two or more feedstocks and an ionic liquid (IL).

2. The composition of claim 1, wherein the two or more feedstocks comprises a softwood feedstock, hardwood feedstock, grass feedstock, or agricultural feedstock.

3. The composition of claim 2, wherein the two or more feedstocks are chosen from a group consisting of softwood feedstock, hardwood feedstock, grass feedstock, and agricultural feedstock.

4. The composition of claim 1 comprising three or more feedstocks.

5. The composition of claim 1, wherein the composition has a temperature from about room temperature to about 200 ° C.

6. The composition of claim 1, further comprising one of more cellulases, or functional variant thereof.

7. A method for treating feedstocks, comprising providing a composition of the present invention comprising two or more feedstocks and an ionic liquid (IL).

8. The method of claim 7, wherein the providing step comprises adding or mixing two or more feedstocks and an IL to a solution to form the composition.

9. The composition of claim 7, wherein the two or more feedstocks comprises a softwood feedstock, hardwood feedstock, grass feedstock, or agricultural feedstock.

10. The composition of claim 9, wherein the two or more feedstocks are chosen from a group consisting of softwood feedstock, hardwood feedstock, grass feedstock, and agricultural feedstock.

11. The method of claim 7, further comprising incubating the composition for equal to or more than 1 h, 2 h, or 3 h.

12. The method of claim 7, further comprising introducing to the composition one of more cellulases, or functional variant thereof, wherein the one or more cellulases hydrolyze cellulose in the composition into one or more sugar.

13. The method of claim 12, wherein the sugar is a monosaccarride or polysaccharride.

14. The method of claim 13, wherein the monosaccarride is glucose.

15. The method of claim 14, wherein the glucose yield is equal to or at least 50%.

16. The method of claim 13, wherein the polysaccharride is xylose.

17. The method of claim 16, wherein the xylose yield is equal to or at least 40%.

18. The method of claim 12, further comprising recovering the sugar from the composition
